(19) United States
(12) Patent Application Publication
(10) Pub. No.: US 2005/0033956 A1
(43) Pub. Date: Feb. 10, 2005

(54) Method and system for the authorised decoding of encoded data

(76) Inventor: Stefan Krempl, Munchen (DE)

Correspondence Address: Ip Strategies, Suite 1, 12 1/2 Wall Street, Asheville, NC, 28801, US

(21) Appl. No.: 10/491,937

(22) PCT Filed: Sep. 24, 2002
(86) PCT No.: PCT/EP02/10694

(30) Foreign Application Priority Data
Oct. 5, 2001 (EP) 01123887.0

(51) Int. Cl. H04L 9/32; G06F 12/14

(52) U.S. Cl. 713/156; 713/176; 713/193

(57) ABSTRACT

The present invention relates to a method and a system for authorized decryption of encrypted data. First, the encrypted data is provided. Then the validity of at least two certificates is verified. If the validity check is positive, a key is provided, which can be used to decrypt the encrypted data.

### FIELD OF INVENTION

The present invention relates to a method and a system for authorized decryption of encrypted data, particularly by means of certificates.

### PRIOR ART

Due to its nature, electronic and digital data can, in principle, be readily duplicated without restriction. Protecting the copyright of such data is therefore problematic because technical hurdles can often be overcome using relatively simple means, and because, as in the case of DVD copy protection, means of by-passing such hurdles are even published on the Internet. Persons including the author, publishers, and producers on the other hand are interest in having data decrypted and used only by authorized persons (e.g. against payment).

The object of the present invention therefore is to provide a method and a system for authorized decryption of encrypted data, which prevents easy, unauthorized copying of data while at the same time allowing easy user handling.

### DESCRIPTION OF INVENTION

This object is achieved by the method according to claim 1 and the system according to claim 14.

According to the method, encrypted data is provided. If at least two certificates are valid, a key is supplied with which the data is decrypted. This method has the benefit that the data can be distributed using open communication channels. This way, the distribution and sales of the data, the acquisition of the right to decrypt and use such data, and the actual decryption and the use of same can be performed independent of each other. The use of at least two certificates provides secure and efficient prevention against unauthorized copying of data.

The terms key and certificate are used in a cryptographic sense. A key is used to transform plaintext to ciphertext, and ciphertext to plaintext. Plaintext is not necessarily human-readable text, but directly useable data, for example, text data or visual data, a computer program, a playable audio or video file or the like. Encryption and decryption performed with the same key is called symmetrical encryption, while the opposite is called asymmetrical encryption. One example of the latter are public-key encryption methods where one “public key” is public, i.e. readily available. The counterpart is the “private key”, which is known only to a limited number of people, possibly only to one person. A certificate can be used to identify a person or data. It can contain one or more keys and the permission/authorization to access and use certain data or devices. Certificates can have a time-stamped validity.

The data is electronic data, for example audio or video data, text-based documents or computer programs. It can exist in analog or digital format and can be stored on any storage medium. The storage medium may be directly accessible, such as memory on a LAN (server, network attached storage, etc.), Internet server memory, portable memory, memory in a reading device/drive (for example diskettes, CD-ROM). The data is provided by a publisher or supplier, for instance an author/originator, producer, publisher, distributor or seller.

The data is preferably encrypted symmetrically. In contrast to other methods, the data can be stored in standard file formats and does not require special “security containers” using proprietary or even secret formats.

In a preferred embodiment, the key is provided by having it determined, for example calculated, by at least two certificates. If the data has been encrypted for a specific user with said user's public key, the key can also be calculated using the private key of said user. The key may also be determined by an additional certificate of the publisher of the data.

As an preferred alternative, the key is provided over a data, telephone, or radio network, whereby it can exist already or it can be created on demand. Storage or creation can be handled by a system of the data issuer. The key can be determined with the issuer's private key and is preferably provided in encrypted format. Encryption can be asymmetric and can, for example, be performed with the public key of the user. The public key can be contained in the user certificate. Using public-key encryption solves the distribution of keys. When the key has been provided it can be stored by the user to a storage unit.

Further to the encrypted data, additional information is preferably provided. It can be used to identify the encrypted data without it having to be decrypted and it can contain an indicator of the content (e.g. serial number) and/or the issuer (e.g. certificate, URL).

Apart from the encrypted data, additional information can be provided which can be used to furnish the key for the encrypted data. This information can be encrypted with the private key of the issuer. Should it not be possible to supply the key with the said additional information, new additional information can be supplied with or without a new encrypted file.

Advantageously, in addition to the encrypted data, further information is provided which contains parts of the encrypted data in unencrypted form. This so-called teaser can serve marketing purposes. It can be used without decryption, for example, it may be executable as a program.

In order to obviate attempts of fraud, the additional information can be cryptographically secured, i.e. encrypted and/or digitally signed by the issuer. It can have the format of a certificate.

Advantageously, the minimum of two certificates include attribute and/or user certificates. Where two certificates are used these can be an attribute and a user certificate or two attribute certificates or two user certificates. A user certificate helps to identify the users. These include, for example, natural persons, legal persons, or devices like data processing equipment. The certificate contains relevant information like name, email address or identification number/serial number. The permission/authorization to use certain data can be stored in an attribute certificate, which is specific to selected data or bulk data. The attribute certificate can be user-specific. It can contain restrictions regarding place, time, user devices (e.g. data processing equipment and play-back units) or other characteristics. In comparison with other methods, the use of attribute certificates ensures portability of data use. The permission to use content is not given to a particular machine or software, but can actually be assigned to a person or a portable device like a chip card.

The use of standards averts the need for what are normally less tested proprietary methods. Because of its nature, the attribute certificate does not have to be kept secret and can be published on storage services available on the Internet. Thus, loss can be avoided and a certificate recovery can be ensured by simple mechanisms. This applies in particular where an attribute certificate granting permission is not based on the public key of the user but on his or her identity (e.g. “distinguished name” of the certificate).

The validity check of the minimum two certificates is preferably carried out in a data processing device of the certificate issuer. Alternatively, it can be performed by the user or a third party (e.g. a trust center). The validity can also be checked using additional information assigned to the data. Particularly if the validity is not checked by the issuer, it is advantageous to include further certificates like the issuer certificate in the validity check. The validity can be verified in various steps: The validity of the individual certificates is verified. It can also be verified if the certificates match one another and if they possibly match any additional information assigned to the data. Should the validity check yield a negative result, for example, if one of the certificates has expired, the user can be issued a new certificate or the certificate can be updated.

It is advantageous to check the validity of the minimum two certificates in a portable data processing device, particularly a Notebook, electronic organizer or mobile phone.

After decryption, the data may be stored. To avoid unauthorized copying, further use of the data may preferably be direct.

An advantageous method for an authorized execution of an encrypted data processing program comprises the following steps: Decryption of the encrypted data processing program using one of the abovementioned methods, loading of the data processing program to the internal memory of a data processing device, and execution of the data processing program by the data processing device. If the data processing program is directly loaded to an internal memory after decryption, the data processing program does not need to be saved.

An advantageous method for an authorized play-back of encrypted acoustic or optical data comprises the following steps: Decryption of the encrypted acoustic or optical data using one of the abovementioned methods, forwarding the acoustic or optical data to the play-back device. The play-back devices include, for example, monitors, speakers, stereo systems, amplifiers, or electronic books. Advantageously, the play-back devices allow for only one play-back and no direct copying of the data. The data can be forwarded in a streaming media format to the play-back device.

Particularly during the play-back on portable play-back devices, saving the content to the play-back device may be necessary, if no wireless connection is to be maintained continuously. In this case, the security can be ensued in different ways:

a) The play-back device itself allows for play-back of the content only and no replication or duplication. In this case, the decrypted content can be transferred to the device after it has been identified.

b) The play-back device has a secured cryptographic module. The content can be stored encrypted along with the key on the device.

c) The play-back device has a secured cryptographic module and the possibility to store a special key. The data can then be transferred with the special key and stored on the play-back device. To access and use the data, it can be decrypted with the special key.

d) The play-back device has a secured cryptographic module and a connection possibility for a cryptographic module. The data can then be stored along with the encrypted key on the play-back device. To use the data, it is decrypted with the provided key.

Advantageously, if at least two certificates are valid, a key is provided by means of a computer program which can be loaded directly or indirectly to the internal memory of a computer and which includes coded segments that can provide a key if at least two certificates are valid.

A system for authorized decryption of encrypted data, particularly for performing one of the methods mentioned above, contains a cryptographic module and at least one storage unit containing at least two certificates. If the system comprises several storage units, the minimum two certificates can be stored in one or different storage units.

Preferably, the cryptographic module and/or the storage unit are located in secure data processing devices. These may be data processing devices whose cryptographic module and/or storage unit cannot be accessed (restricted/or fully) and controlled from outside the data processing device. Preferably, one or more cryptographic data processing devices and data memories are used. The greater the damage which is expected to arise from a compromised function, the higher the security and the effort needed to overcome this security function become. Thus, the system can benefit from the efficiency of inexpensive standard components like personal computers and can have the security of special items such as chip cards and chip card readers.

It is advantageous if the system for authorized decryption of encrypted data has the cryptographic module and at least one storage unit with at least two certificates stored in a chip card. In this case, cryptographic functions including the decryption of the available encrypted key can be performed in the chip card. Such a chip card can be a USB token.

In a system for authorized decryption of encrypted data it is advantageous to use a chip card reader with memory and one stored certificate. This can be a user certificate.

A chip card reader, which is paticularly used in a system for authorized decryption of encrypted data, preferably contains a cryptographic module. In this case, cryptographic functions can be performed in the chip card reader.

The following describes specific embodiment of the invention with reference to the attached drawings, which show in:

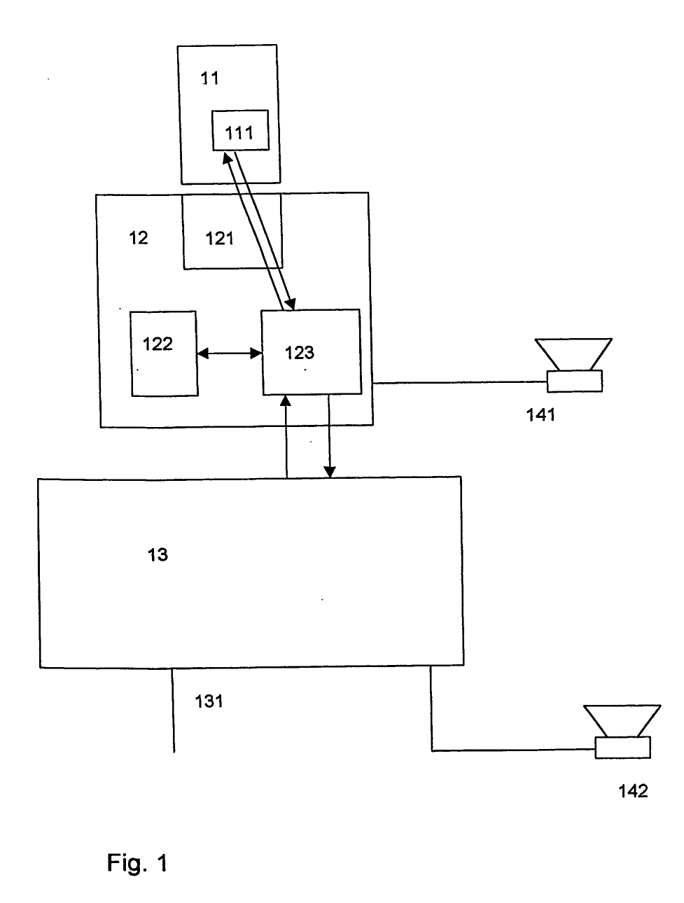

FIG. 1 a system for authorized decryption of encrypted data with play-back devices,

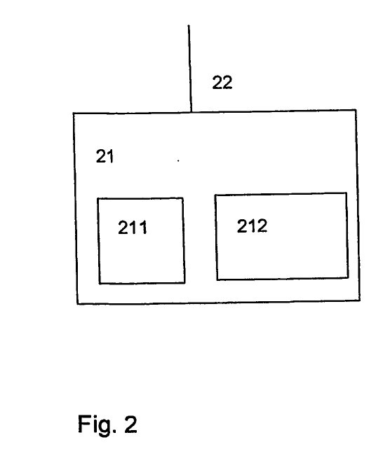

FIG. 2 a background system, and

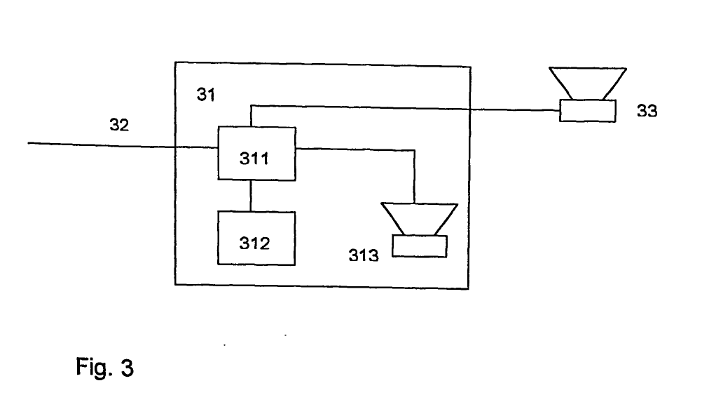

FIG. 3 an independent use.

FIG. 1 shows a system for authorized decryption of encrypted data with play-back devices. A secure data processing device 11 (e.g. chip card) contains a memory 111. The secure data processing device is permanently or temporarily connected to a secure data processing device 12 (e.g. chip card reader, slide-in module, mobile telephone, computer mouse, keyboard, and remote control for electronic devices). The secure data processing device 12 comprises a connection unit 121 for the connection with the secure data processing device 11, a storage unit 122, and a cryptographic module 123. The communication between the secure data processing devices 11 and 12 is cryptographically secured, e.g. by secure messaging. The communication can be established by electronic contacts, wireless, or over telecommunication channels.

The secure data processing device 12 is connected to a user or play-back device 141 and a data processing device 13. The data processing device 13 can, for example, be integrated in a computer, a television, a stereo system, a video system, an MP3 player, an eBook, a data terminal, a thin client or a workstation. The data processing devices 12 and 13 can together be integrated in he same physical unit.

The data processing device 12 and/or the data processing device 13 can be connected to a user or a play-back device 141, 142, such as loudspeakers, headset, monitor, television, stereo system, MP3 player, eBook, Internet applications, computer, organizer or PDA. Furthermore, the data processing device 13 has a permanent or temporary connection 131 to a data, telephone or radio network.

The encrypted data and its additional information are stored on the data processing device 13, an external storage medium, or can be accessed by LAN or WAN connection. The attribute certificate, which is specific to certain data and the user, can be acquired by standard e-commerce methods. The user acquires an attribute certificate which is specific to the user (user certificate) and to certain content, and which he/she stores in any memory. Alternatively, the user acquires a portable storage medium or a portable data processing device, which has a certificate stored that is specific to the storage medium or the user and an attribute certificate that is specific to the content. According to a further alternative, the user acquires a portable storage medium containing the attribute certificate.

The attribute certificate can be saved to a repository, which may already contain other attribute certificates of the user. The repository can be located on one of the data processing devices 11, 12 or 13, or any place on the WAN or Internet. From a cryptographic perspective it is public. The data processing device 11 or 12 contains the user certificate.

FIG. 2 shows a checkpoint 21 for verifying the validity of the certificates. From data processing device (e.g. data processing devices 11,12 or 13 in FIG. 1) user and attribute certificates and additional information are sent to the checkpoint 21 (e.g. issuer, trust center) over a data or telephone network 22 and saved to a storage unit 211. The checkpoint verifies the validity of each certificate and checks if they match. If the verification is positive, a key is provided. If the key embedded in encrypted form in the additional information, it is decrypted using the cryptographic module 212. According to another method, the key is computed from the additional information. If the certificates have expired, a new encrypted file is sent to the user and/or the certificate is updated.

The key is encrypted by the cryptographic module 212 using the public key of the user certificate and is sent to the user. Additional information, optionally signed by the issuer, can be appended to the encrypted key.

The encrypted key can be decrypted or calculated e.g. in the data processing device 11 in FIG. 1 and transferred to the data processing device 12 in FIG. 1. If corresponding information is contained in the additional information, the key can be permanently or temporarily saved to the data processing device 12 in FIG. 1. This means that it does not have to be obtained again for repeated decryption.

An unsecure data processing device (e.g. data processing device 13 in FIG. 1) sends the encrypted data as a data stream to a secure data processing device (e.g. data processing device 12 in FIG. 1). Here, the data is decrypted and the data stream is either sent back to the unsecure data processing device or directly to the play-back device (e.g. play-black device 141 in FIG. 1). If the data is a computer program, it can be loaded to the unsecure data processing device and executed.

According to a an embodiment not presented, the validity check can also be performed in a data processing device located on the user side (e.g. secure data processing device 11 or 12 or unsecure data processing device 13 in FIG. 1). If the check yields a positive result, the key can be calculated in one of the data processing devices (preferably a secure device). Alternatively, the key can also be requested over a data or telephone network. The key can be sent either encrypted (e.g. public key) or unencrypted.

A particular embodiment of a play-back device 31 is shown in FIG. 3. It has a connection 32 to a data processing device and consists of a storage unit 312, a cryptographic module 311, and an integrated play-back device 33. The connection of an external play-back device 33 is optional. In this case, the encrypted data and the key can be saved together in the play-back device. The data is then decrypted on demand.

1. Method for authorized decryption of encrypted data with the assistance of a minimum of two certificates in the following order:
a) Provision of encrypted data
b) Provision of a key, if the validity of the two certificates has been verified
c) Decryption of the data using the key

2. Method according to claim 1 in which the key is provided after having been determined with the help of the minimum two certificates.

3. Method according to claim 1 in which the key is provided over a data, telephone, or radio network.

4. Method according to claim 3, in which the key is provided in encrypted form.

5. Method according to claim 1, in which apart from the encrypted data additional information is provided to identify the encrypted data without the need for decryption.

6. Method according to claim 1, in which apart from the encrypted data additional information is provided to procure the key for decrypting the encrypted data.

7. Method according to claim 1, in which apart from the encrypted data additional information is provided which contains some of the encrypted data in unencrypted form.

8. Method according to claim 1 in which the minimum two certificates comprise attribute and/or user certificates.

9. Method according to claim 1, in which the validity of the minimum two certificates is verified in a data processing device of an issuer or a user.

10. Method according to claim 1, in which the validity is verified in a portable data processing device, particularly a notebook, an electronic organizer or a mobile phone.

11. Method for an authorized execution of an encrypted data processing program in the following steps:
a) Decryption of the encrypted data processing program using methods according to claim 1.
b) Loading of the data processing program to the main memory of a data processing device.
c) Execution of the data processing program by the data processing device.

12. Method for an authorized play-back of encrypted acoustic and optical data in the following steps:
a) Decryption of the encrypted acoustic and optical data using the method according to claim 1.
b) Forwarding of the acoustic and optical data to a play-back device.

13. Computer program product, which can be directly or indirectly connected to the main memory of a computer and which consist of coded segments that provide a key if a minimum of two certificates are valid according to step c) of the method of claim 1.

14. System for authorized decryption of encrypted data, in particular for performing the method claim 1 with a cryptographic module and at least one storage unit with a minimum of two stored certificates.

15. System according to claim 14, in which the cryptographic module and the minimum of one storage unit with at least two stored certificates are intended for a chip card.

16. Chip card reader, in particular for use in a system for authorized decryption of encrypted data according to claim 14 with a storage unit containing one certificate.

17. Chip card reader, in particular for use in a system for authorized decryption of encrypted data according to claims 14 with a cryptographic module.
